(19) United States
(12) Patent Application Publication
(10) Pub. No.: US 2002/0108279 A1
(43) Pub. Date: Aug. 15, 2002

(54) Advertising cover for insulated beverage box

(76) Inventors: Frazier Q. Hubbard II, Vallejo, CA (US); Andrea M. Blake, Hayward, CA (US)

Correspondence Address: Andrea M Blake, 737 Medford Ave, Hayward, CA, 94541, US

(21) Appl. No.: 09/780,851

(22) Filed: Feb. 12, 2001

(51) Int. Cl. G09F 3/00; G09F 1/00

(52) U.S. Cl. 40/312; 40/720

(57) ABSTRACT

Advertising cover for insulated beverage box with the: a rectangular box structure having an open bottom portion and a partially open rear portion, the box sides and top each having a cut out portion, the cut out portions capable of accepting clear plastic windows for the purposes of displaying an advertising graphic, the rectangular box made of eighth inch thick die cut corrugated plastic and riveted together, the plastic windows made of vacuum formed clear plastic such as PET or vinyl so that the top surface of said clear plastic is flush with the top surface of said corrugated plastic, a plurality of removable replaceable advertising graphic cards that reside under said clear plastic windows, and said advertising graphic cards held in place by a removable replaceable flange that is held to the inside perimeter of said cutout portions of said advertising cover by standard hook and loop type fastening material.

### BACKGROUND OF THE INVENTION

This invention relates generally to the field of advertising displays, and more particularly to an advertising display cover for an insulated beverage dispensing box.

During sporting events or rock concerts or the like it is common that beverages are sold and served in the nearby halls or adjacent rooms of the event. The beverages are often stored in kegs that are kept cool by storing them in insulated boxes, often called Jockey Boxes. The jockey box is usually a modified cooler similar to those used by people on camping trips or beach outings. A typical box is one made by Rubbermade and called an Ice Chest and has a twelve gallon capacity. Typically a dispensing tap is secured to the outside of the box and hoses are connected from the internal keg to the dispensing tap. The dispensing tap is turned toward the server and the customer is usually stationed on the opposite side of the jockey box facing the server Jockey boxes are a proven and convenient way to store and dispense beverages at sporting or musical events or the like.

Currently, jockey boxes are simply modified insulated coolers. They have no ability to accept advertising graphics. Since customers may standing in front of the jockey box for an extended period of time waiting to be served a drink, a golden opportunity is being missed to communicate an advertising message to a potential customer. Additionally, the drink vendor is missing an opportunity at advertising revenue that might be gained from the sale of advert zing space. Finally, an uncovered, insulated cooler box presents an unflattering ordinary appearance that does not enhance the value of the beverage being served.

### SUMMARY OF THE INVENTION

The primary object of the invention is to provide a means to display advertising graphics on an insulated beverage dispensing box.

Another object of the invention is to provide a means for easily changing the advertising graphics to suit a particular sporting or other event.

Another object of the invention is to provide a means for protecting said advertising graphics from liquid spills.

A further object of the invention is to provide a water resistant advertising display means that can be easily added or removed from a standard insulated beverage dispensing box, also known and a Jockey Box.

Other objects and advantages of the present invention will become apparent from the following descriptions, taken in connection with the accompanying drawings, wherein, by way of illustration and example, an embodiment of the present invention is disclosed.

Advertising cover for insulated beverage box comprising the: a rectangular box structure having an open bottom portion and a partially open rear portion, said box sides and top each having a cut out portion, said cut out portions capable of accepting clear plastic windows for the purposes of displaying an advertising graphic, said rectangular box made of eighth inch thick die cut corrugated plastic and riveted together, said plastic windows made of vacuum formed clear plastic such as PET or vinyl so that the top surface of said clear plastic is flush with the top surface of said corrugated plastic, a plurality of removable replaceable advertising graphic cards that reside under said clear plastic windows, and said advertising graphic cards held in place by a removable replaceable flange that is held to the inside perimeter of said cutout portions of said advertising cover by standard hook and loop type fastening material.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective rear view of the jockey box cover of the present invention

FIG. 2 is a front perspective view of the jockey box cover of the present invention

FIG. 3 is an open plan view of the corrugated die cut pattern for making the jockey box cover of the present invention

FIG. 4 is an exploded view of the advertising window portion of the present invention

FIG. 5 is a side section view of the present invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

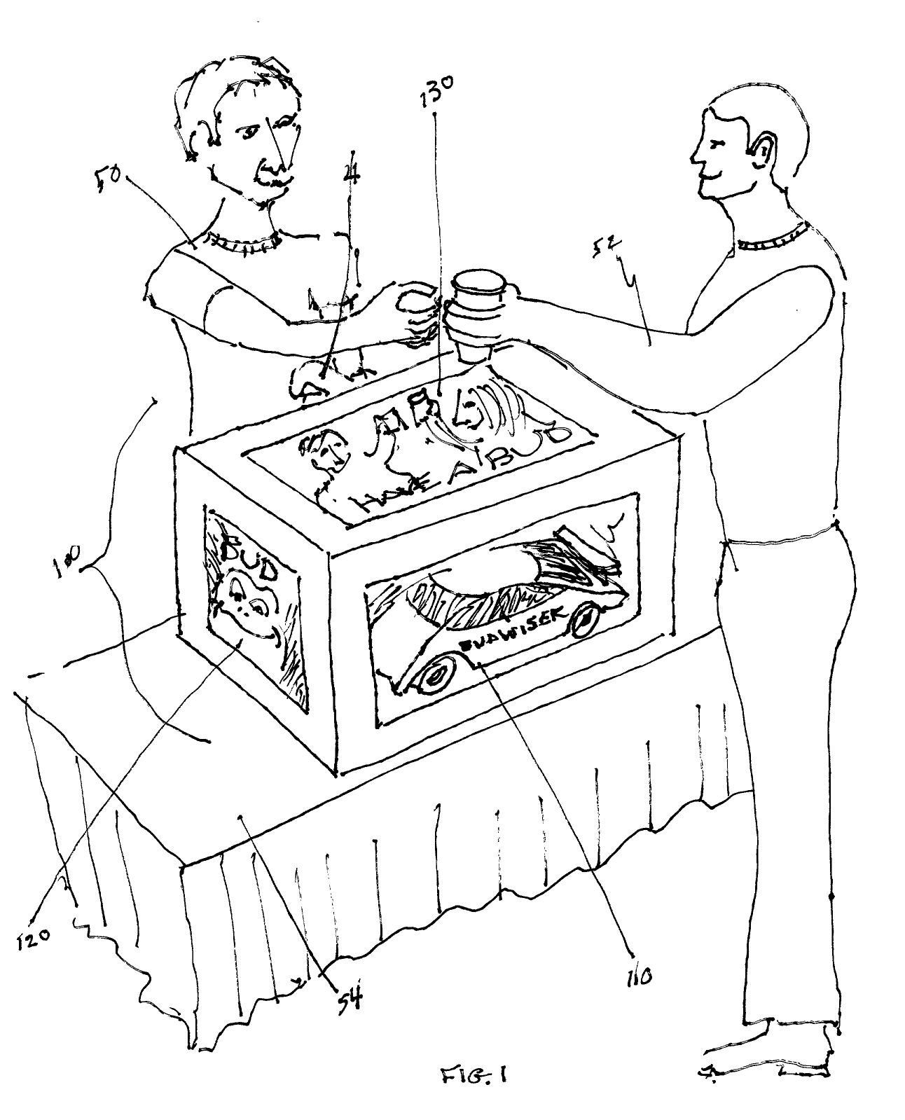

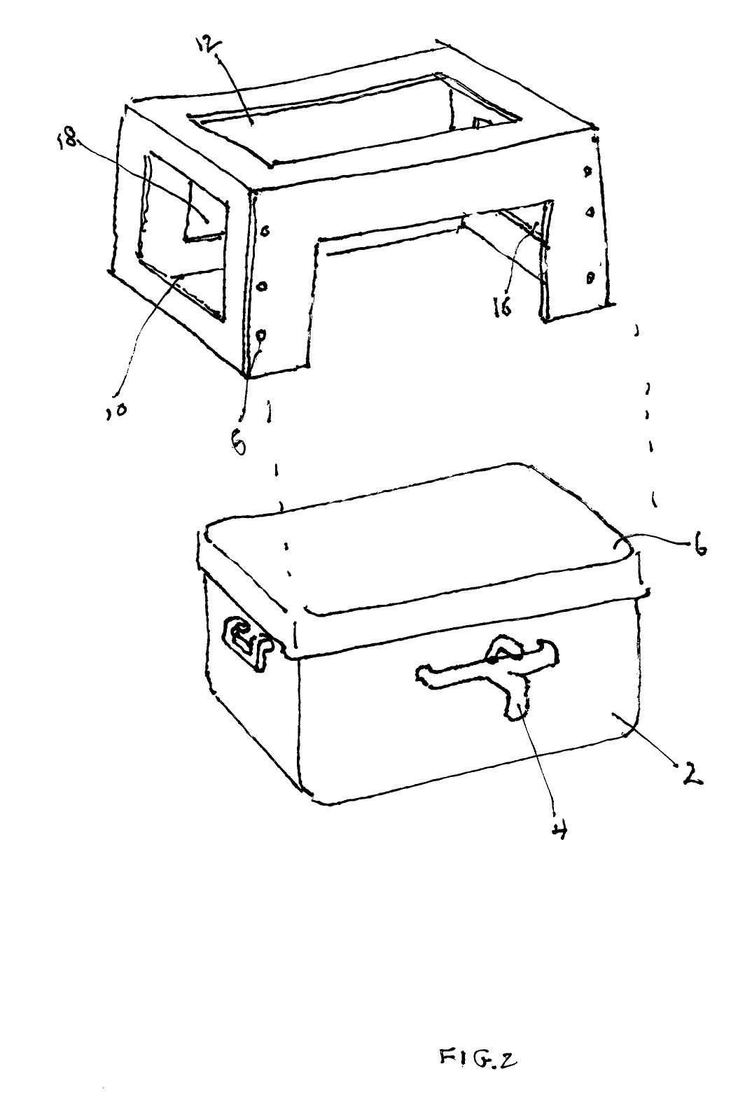

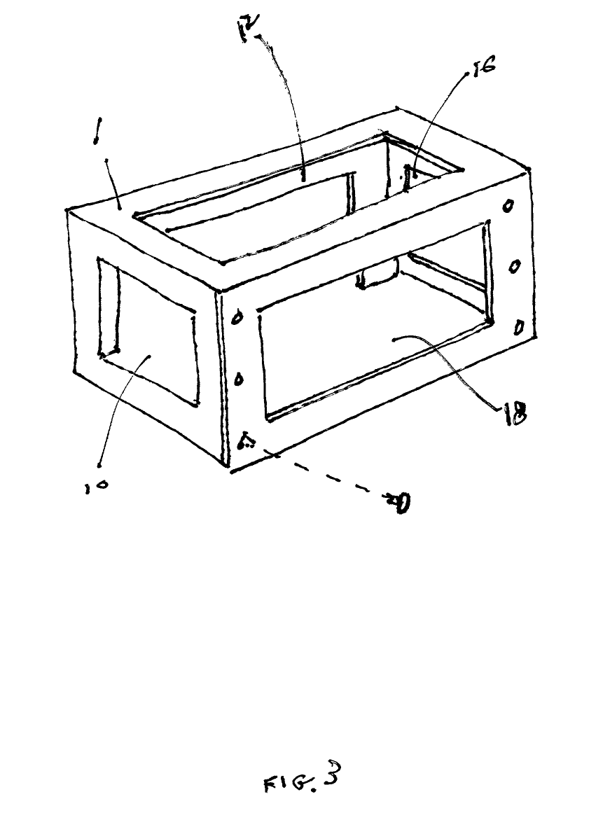

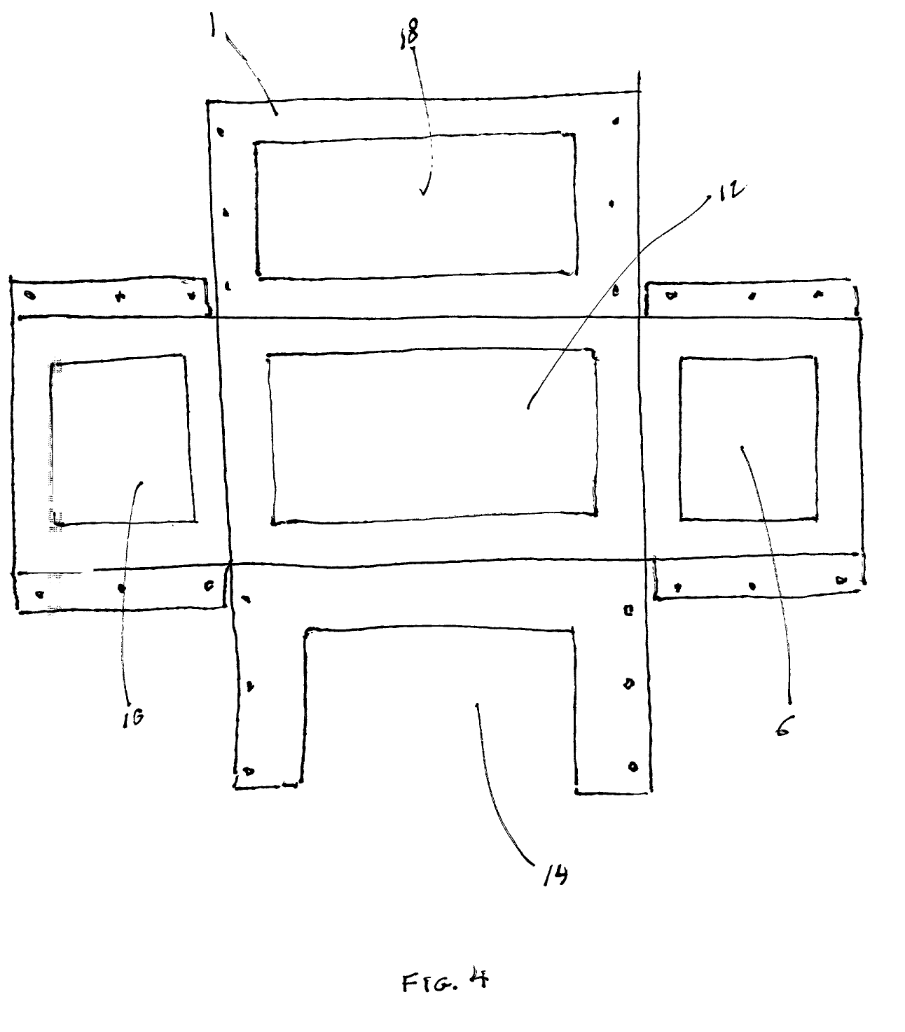

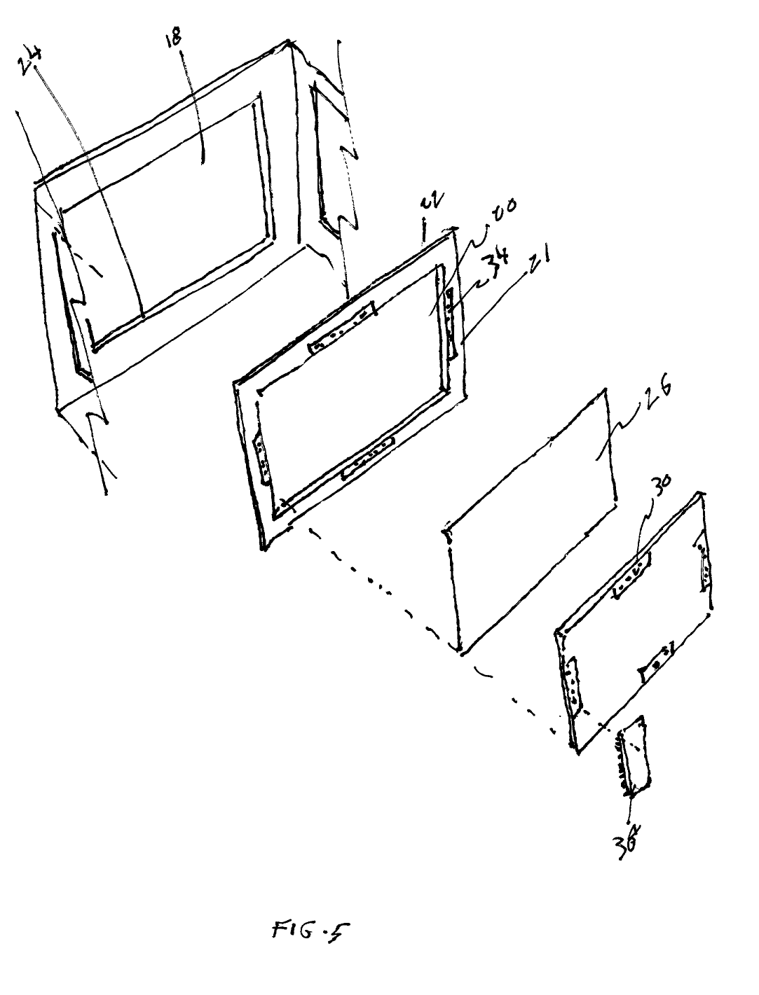

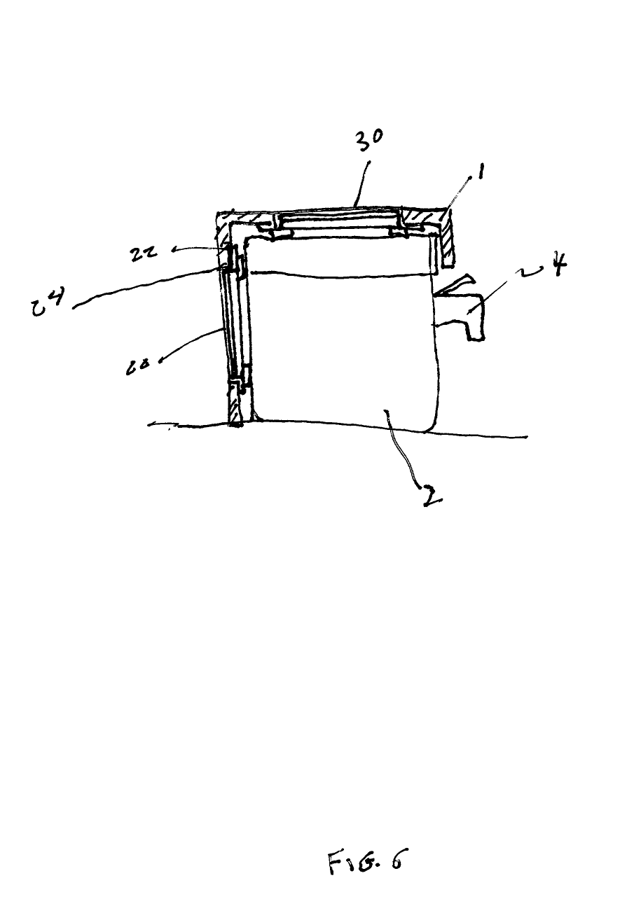

Referring now to FIG. 1 we see a the jockey box cover 100 of the present invention in use during a sporting or other entertainment event. The box traditionally sits on a table top 54 or the like. The box cover 100 has a plurality of clear windows that allow advertising graphics 110, 120, 130 to show through so that when a person 52 is waiting to be served by a server 50 he or she can view the advertising. The advertising graphics 110, 120, 130 are removable and replaceable so that they can be customized to a particular sporting or entertainment event,. For example, a car racing event may prompt the advertiser to insert photos of racing cars along with the logo of the advertiser. The rear portion of the box cover 100 is open so that the beverage dispensing means is easily accessible to the server 50. FIG. 2 shows how the box cover 100 of the present invention lowers onto a standard ice chest type cooler 6, 2 such the model 1946 manufactured by Rubbermaid Corp which has a twelve gallon capacity. The ice chest is fitted with a dispensing spigot 4 and often referred to in the trade as a jockey box. The rear portion of the box cover 100 is cut out 14 so as to clear the spigot 4. The box cover simply slips over the ice chest body 2 and cover 6. FIG. 3 shows a perspective box cover frame 1 from the front. The structure is die cut from corrugated plastic such as high density polyethelne or the like. The structure is made from a single sheet of material and scored and folded to create the box like structure. Rectilinear window portions 10, 12, 16, 18, are cutout to allow for viewing of advert zing graphics. The box structure is held together by rivets 8. FIG. 4 is a plan view of the die cut box structure 1 of the present invention. FIG. 5 is an exploded view of the window insert portion 20 of the present invention. The window inerts 20 are vacuum formed from a clear plastic sheeting such as PET or vinyl. The side wall 21 is approximately one eighth of an inch tall which is the same as the thickness of the corrugate plastic structure 1 so that when the window 20 is in place in the box structure 1 it is flush with the top surface of the box structure 1. Integral flange 22 acts to reinforce window 20 and also acts as a retaining means to hold the window to the cutout position 18. Double sided adhesive 24 fixedly adheres the window 20 to the opening perimeter. Hook type fastening material 34 is placed around the inward facing flange 22. Advertising graphic 26 can be removably replaced into window portion 20. Stiffener card 32 fits behind advertising graphic 26 and keeps the graphic 26 pressed to the forward most portion of window 20. Closure strips 28, 30 have loop type fastening material 38 fixedly attached to their fronts so that they can removably mate with hook type fasteners 34. FIG. 6 shows a side section view of the box cover of the present invention 100 This view more clearly shows the relationship of all components. The entire box cover assembly is water resistant thereby reducing the chance of liquid from spilled drinks and the like to damage the box cover and associated graphics In the above described and illustrated way the present invention provides a novel means to display advertising on a jockey box cover and to be able to easily remove and reinsert advertising panels depending on the type of entertainment event taking place during the use of the jockey box.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Advertising cover for insulated beverage box comprising the:
a rectangular box structure having an open bottom portion and a partially open rear portion;
said box sides and top each having a cut out portion;
said cut out portions capable of accepting clear plastic windows for the purposes of displaying an advertising graphic;
said rectangular box made of eighth inch thick die cut corrugated plastic and riveted together;
said plastic windows made of vacuum formed clear plastic such as PET or vinyl so that the top surface of said clear plastic is flush with the top surface of said corrugated plastic;
a plurality of removable replaceable advertising graphic cards that reside under said clear plastic windows; and
said advertising graphic cards held in place by a removable replaceable flange that is held to the inside perimeter of said cutout portions of said advertising cover by standard hook and loop type fastening material.
